(19) United States
(12) Patent Application Publication
(10) Pub. No.: US 2025/0291758 A1
(43) Pub. Date: Sep. 18, 2025

(54) STORAGE SYSTEM AND STORAGE SYSTEM MANAGEMENT METHOD

(71) Applicant: Hitachi Vantara, Ltd., Yokohama (JP)

(72) Inventor: Masateru HEMMI, Tokyo (JP)

(21) Appl. No.: 18/882,682

(22) Filed: Sep. 11, 2024

(30) Foreign Application Priority Data
Mar. 15, 2024 (JP) 2024-041769

(51) Int. Cl. G06F 13/40; G06F 13/16; G06F 13/24

(52) U.S. Cl. CPC G06F 13/4022; G06F 13/1642; G06F 13/24

(57) ABSTRACT

Provided is a storage system and a storage system management method that are capable of providing continuous I/O processing by switching a queue used for I/O control on a controller side. The storage system includes a first protocol chip, a second protocol chip, a first controller, and a second controller. The first protocol chip and the second protocol chip receive I/O commands from a host. The first controller includes a first CPU. The second controller includes a second CPU. In accordance with an instruction from the first controller, the first protocol chip halts the first CPU, and switches a Qset for sending the I/O commands received by the first protocol chip from Qset 11 to Qset 12.

### CROSS-REFERENCE TO RELATED APPLICATION

The present application claims priority from Japanese application JP2024-041769, filed on Mar. 15, 2024, the content of which is hereby incorporated by reference into this application.

### BACKGROUND

The present invention relates to a storage system and a storage system management method.

The storage system includes a protocol chip and a controller. The protocol chip receives an I/O command from a host, and sends the I/O command to the controller. The controller receives the I/O command from the protocol chip, and provides I/O control. The storage system is configured such that the protocol chip and the controller are connected through a PCI (Peripheral Component Interconnect) bus on a one-to-one basis.

A queue control method is used for interfacing between the protocol chip and a CPU of the controller. The CPU uses a queue to receive the I/O command received by the protocol chip and to send an I/O processing request to the protocol chip. The queue is assigned to each core or each CPU.

In some cases, the controller uses a multicore CPU in the AMP (Asymmetrical Multiprocessing) OS. In the CPU of the AMP OS, a standalone OS (Operating System) runs on each core. When an OS update is to be performed, the OS can be updated individually for each standalone OS running on each core of CPU. Therefore, even if the adopted configuration is such that the protocol chip and the controller are connected on a one-to-one basis, a non-disruptive OS update can be performed without interrupting I/O control for communicating with a host server as long as a core not targeted for OS update provides I/O control in a substitute manner.

Meanwhile, in some other cases, the controller uses a multicore CPU in the SMP (Symmetric Multiprocessing) OS. In the CPU of the SMP OS, a single OS runs on a plurality of cores. When an OS update is to be performed, it is necessary to simultaneously halt a plurality of cores of the CPU because the protocol chip and the controller are connected on a one-to-one basis and the OS cannot be updated on an individual core basis unlike the CPU in the AMP OS.

If the CPU comes to a complete halt, no existing CPU cores perform I/O processing. As a result, no cores handle I/O processing. Further, the queue becomes unavailable, resulting in the loss of I/O control information stored in the queue. Furthermore, the above also results in the loss of all I/O commands that are received from the host server by the protocol chip while the CPU is halted. Due to the above-mentioned factors, performing an SMP OS update causes problems in which I/O processing may stop and the link with the host server may be cut off.

The above problems may also occur in other cases, such as when a fault occurs to halt the entire CPU.

### SUMMARY

Consequently, when the controller CPU comes to a complete halt, it is necessary to implement a mechanism for providing continuous I/O control by switching the queue used for I/O control on a controller side from a queue assigned to a halted CPU to a queue assigned to another controller CPU that is not halted. It should be noted that Japanese Unexamined Patent Application Publication (Translation of PCT Application) No. 2012-514776 and International Publication WO 2016/006111 do not describe a mechanism that, as described in conjunction with the present invention, switches the queue used for I/O control on the controller side from a queue assigned to a halted CPU to a queue assigned to another controller CPU that is not halted.

One of the objectives of the present invention is to provide a storage system and a storage system management method that are capable of providing continuous I/O processing by switching a queue used for I/O control on the controller side.

In order to solve the above problems, according to an aspect of the present invention, there is provided a storage system including a first protocol chip, a second protocol chip, a first controller, a second controller, a first PCI switch, and a second PCI switch. The first protocol chip and the second protocol chip receive I/O commands from a host. The first controller includes a first CPU to which a queue used for control communication with the first protocol chip and a queue used for control communication with the second protocol chip are assigned. The second controller includes a second CPU to which a queue used for control communication with the first protocol chip and a queue used for control communication with the second protocol chip are assigned. The first PCI switch is disposed between the first protocol chip and the first and second CPUs and configured to set a communication path between the first protocol chip and the first CPU and a communication path between the first protocol chip and the second CPU. The second PCI switch is disposed between the second protocol chip and the first and second CPUs and configured to set a communication path between the second protocol chip and the first CPU and a communication path between the second protocol chip and the second CPU. The first protocol chip and the second protocol chip each have queue control information that defines the queue at a transmission destination of the I/O commands received from the host, and cause the first and second PCI switches to set the communication path for the I/O commands in accordance with the queue control information.

According to another aspect of the present invention, there is provided a storage system including a first protocol chip, a second protocol chip, a first controller, a second controller, a first communication path, a second communication path, a third communication path, a fourth communication path, a first PCI switch, and a second PCI switch. The first protocol chip and the second protocol chip receive I/O commands from a host. The first controller and the second controller include a CPU that receives the I/O commands from the first protocol chip and the second protocol chip. The first communication path is between the first protocol chip and the first controller. The second communication path is between the second protocol chip and the second controller. The third communication path is between the first protocol chip and the second controller. The fourth communication path is between the second protocol chip and the first controller. The first PCI switch switches the communication path for the I/O commands received by the first protocol chip to either the first communication path or the third communication path in accordance with an instruction from the controller side. The second PCI switch switches the communication path for the I/O commands received by the second protocol chip to either the second communication path or the fourth communication path in accordance with an instruction from the controller side.

According to yet another aspect of the present invention, there is provided a storage system management method that is applied to a storage system including a first protocol chip, a second protocol chip, a first controller, a second controller, a first PCI switch, and a second PCI switch. The first protocol chip and the second protocol chip receive I/O commands from a host. The first controller includes a first CPU to which a queue used for control communication with the first protocol chip and a queue used for control communication with the second protocol chip are assigned. The second controller includes a second CPU to which a queue used for control communication with the first protocol chip and a queue used for control communication with the second protocol chip are assigned. The first PCI switch is disposed between the first protocol chip and the first and second CPUs and configured to set a communication path between the first protocol chip and the first CPU and a communication path between the first protocol chip and the second CPU. The second PCI switch is disposed between the second protocol chip and the first and second CPUs and configured to set a communication path between the second protocol chip and the first CPU and a communication path between the second protocol chip and the second CPU. The first protocol chip and the second protocol chip each have queue control information that defines the queue at a transmission destination of the I/O commands received from the host, and cause the first and second PCI switches to set the communication path for the I/O commands in accordance with the queue control information.

According to the present invention, it is possible to perform I/O processing continuously by switching the queue used for I/O control on the controller side. It should be noted that advantages described here are not necessarily restrictive. It is to be understood that any advantages described in this disclosure can be provided by the present invention.

### BRIEF DESCRIPTION OF THE DRAWINGS

FIG. 1 is a diagram illustrating an example of the configuration of a system that includes a storage system according to an embodiment of the present invention;

FIG. 2 is a diagram illustrating an interruption table;

FIG. 3 is a diagram illustrating an OXID table;

FIG. 4 is a diagram illustrating a port management table;

FIG. 5 is a diagram illustrating a queue combination table;

FIG. 6 is a diagram illustrating how I/O control is exercised before queue switching;

FIG. 7 is a diagram illustrating how control is exercised to issue a switching instruction for queue switching;

FIG. 8 is a diagram illustrating how control is exercised after the issuance of the switching instruction for queue switching;

FIG. 9 is a diagram illustrating how control is exercised after the issuance of the switching instruction for queue switching;

FIG. 10 is a diagram illustrating how control is exercised after the issuance of the switching instruction for queue switching;

FIG. 11 is a diagram illustrating how control is exercised after the issuance of the switching instruction for queue switching;

FIG. 12 is a diagram illustrating how control is exercised after completion of queue switching;

FIG. 13 is a flowchart illustrating the flow of a queue creation process that is performed by a CPU;

FIG. 14 is a flowchart illustrating the flow of a queue combination table update process that is performed by a first protocol chip through the use of FW (firmware);

FIG. 15 is a flowchart illustrating the flow of an RQ queuing process that is performed by the first protocol chip through the use of FW;

FIG. 16 is a flowchart illustrating the flow of a WQ queuing process that is performed by the first protocol chip through the use of FW;

FIG. 17 is a flowchart illustrating the flow of a CQ queuing process that is performed by the first protocol chip through the use of FW;

FIG. 18 is a flowchart illustrating the flow of a queue switching process that is performed by the first protocol chip through the use of FW;

FIG. 19A is a flowchart illustrating the flow of a queue switching process that is performed by the first CPU through the use of a program;

FIG. 19B is a flowchart illustrating the flow of a queue switching process that is performed by the first CPU through the use of a program;

FIG. 20A is a sequence diagram illustrating operations performed to update an SMP OS that runs on the first CPU; and

FIG. 20B is a sequence diagram illustrating operations performed to update the SMP OS that runs on the first CPU.

### DETAILED DESCRIPTION

An embodiment of the present invention will now be described with reference to the accompanying drawings. It should be noted that, in all the drawings depicting the embodiment, identical or corresponding portions may be designated by the same reference signs. In the following description, various information is occasionally expressed by using expressions such as “tables,” “records,” “columns, and “rows.” However, the various information may be expressed in data structures other than those enumerated above. Further, expressions, such as “numbers,” “names,” and “identifiers,” are used to describe identification information. However, these expressions are replaceable with each other. Furthermore, other expressions may be used to describe the identification information.

### Embodiment

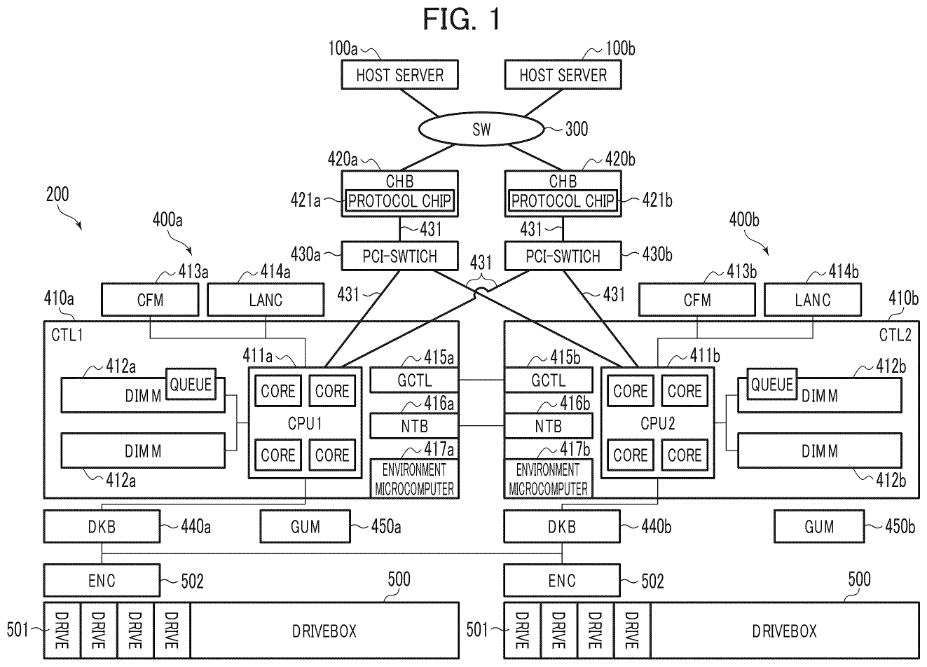

A storage system 200 according to an embodiment of the present invention will now be described. FIG. 1 illustrates an example of the configuration of a system that includes the storage system 200 according to the embodiment. As illustrated in FIG. 1, the system includes a host server 100a, a host server 100b, and the storage system 200. In a case where the host server 100a and the host server 100b need not particularly be distinguished from each other, each of them is occasionally referred to as the “host server 100” or the “host.”

The host server 100 and the storage system 200 are connected through a SAN (Storage Area Network) and a fibre channel switch 300 in such a manner that data can be sent and received.

The fibre channel switch 300 includes a plurality of ports, and connects a plurality of host servers 100 to a first controller section 400a and a second controller section 400b, which are included in the storage system 200. The fibre channel switch 300 provides control over data transmission and reception to ensure network availability and performance.

The host server 100 is a computer (server apparatus) that issues I/O requests. The host server 100 may be a physical computer or a virtual computer. The host server 100 includes a HBA (host bus adapter).

The storage system 200 includes the first controller section 400a, the second controller section 400b, and a plurality of drive boxes 500. In a case where the first controller section 400a and the second controller section 400b need not particularly be distinguished from each other, each of them is occasionally referred to as the “controller section 400.” Each of the first controller section 400a and the second controller section 400b is occasionally referred to as the “storage controller 400.”

The first controller section 400a includes a first controller 410a, a first CHB 420a, a first PCI switch 430a, a first DKB 440a, and a first GUM 450a.

The first controller 410a includes a first CPU 411a, two first DIMMs 412a, a first CFM 413a, a first LANC 414a, a first GCTL 415a, a first NTB 416a, and a first environment microcomputer 417a.

The first CPU 411a is a multicore processor, and includes four cores. Each core performs calculations independently and executes a plurality of processes in parallel. The SMP (Symmetric Multiprocessing) OS runs on the first CPU 411a.

The first DIMMs 412a are memory modules (Dual In-line Memory Modules) that are formed by a plurality of DRAM chips mounted on a printed circuit board. A plurality of queues are created in the first DIMMs 412a. The first DIMMs 412a is occasionally referred to as the “first memories 412a.”

The first CFM 413a is a cache flash memory.

The first LANC 414a is a controller (Local Area Network Controller), and is a device that manages data communication in a LAN (Local Area Network) to ensure efficient communication between devices.

The first GCTL 415a is a control device for controller setup and control. The first NTB 416a is a non-transparent bridge connected to the first CPU 411a. The first NTB 416a is a device that communicatively connects the first controller 410a and a second controller 410b. The first CPU 411a and the second CPU 411b are communicatively connected through a non-transparent link. The first environment microcomputer 417a is a microcomputer used to monitor, control, or manage environmental conditions.

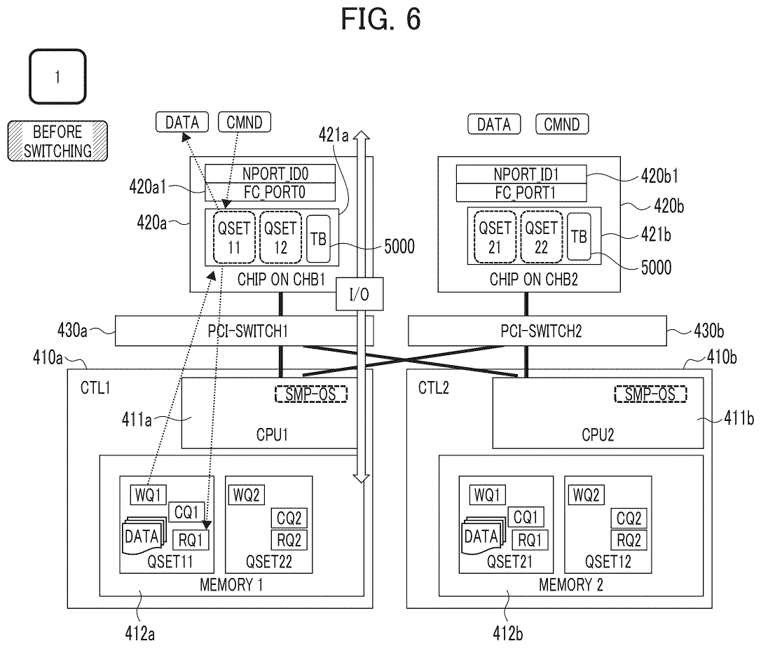

The first CHB (CHannel Board) 420a is a board that controls data transfer between the storage system 200 and the host server 100. The first CHB 420a includes a first protocol chip 421a that is in charge of communication between the storage system 200 and the host server 100 via an FC port 420al (refer, for example, to FIG. 6.)

The FC port 420al is a fibre channel port for connecting the first CHB 420a to the host server 100 through the SAN. The first protocol chip 421a is an ASIC chip (Application-Specific Integrated Circuit) for processing the communication protocol between the storage system 200 and the host server 100. The first protocol chip 421a controls data transfer between the host server 100 and a drive 501 (volume) by processing I/O commands that are issued from the host server 100 to the drive 501 (volume) associated with the host server 100.

The first PCI switch 430a connects a plurality of PCI devices, and adjusts communication between these devices. The first PCI switch 430a has a plurality of ports, and connects a PCI device to each of the PCI ports. Specifically, the first PCI switch 430a has a port connected to the first protocol chip 421a, a port connected to the first CPU 411a, and a port connected to the second CPU 411b.

The first DKB (Disk Board) 440a is an interface that connects the first controller 410a and the drive box 500.

The first GUM (Gateway for Unified Management) 450a is a computer having basic maintenance and management functions for the storage system 200. When the storage system 200 is to be maintained or managed from the outside, communication is performed with the first GUM 450a.

The second controller section 400b includes a second controller 410b, a second CHB 420b, a second PCI switch 430b, a second DKB 440b, and a second GUM 450b. The second CHB 420b includes a second protocol chip 421b that is in charge of communication between the storage system 200 and the host server 100 via an FC port 420b1 (refer, for example, to FIG. 6).

The second controller 410b includes a second CPU 411b, two second DIMMs 412b, a second CFM 413b, a second LANC 414b, a second GCTL 415b, a second NTB 416b, and a second environment microcomputer 417b. The second DIMMS 412b are occasionally referred to as the “second memories 412b.”

The second CPU 411b, the two second DIMMs 412b, the second CFM 413b, the second LANC 414b, and the second environment microcomputer 417b are similar in detail to the first CPU 411a, the two first DIMMs 412a, the first CFM 430a, the first LANC 414a, and the first environment microcomputer 417a. The second CHB 420b (second protocol chip 421b), the second PCI switch 430b, the second DKB 440b, and the second GUM 450b are similar to the first CHB 420a (first protocol chip 421a), the first DKB 440a, and the first GUM 450a. The second PCI switch 430b has a port connected to the second protocol chip 421b, a port connected to the first CPU 411a, and a port connected to the second CPU 411b.

In a case where the first controller 410a and the second controller 410b need not particularly be distinguished from each other, each of them is occasionally referred to as the “controller 410.” In a case where the first CPU 411a and the second CPU 411b need not particularly be distinguished from each other, each of them is referred to as the “CPU 411.” In a case where the first DIMM 412a and the second DIMM 412b need not particularly be distinguished from each other, each of them is referred to as the “DIMM 412.” In a case where the first CHB 420a and the second CHB 420b need not particularly be distinguished from each other, each of them is referred to as the “CHB 420.” In a case where the first protocol chip 421a and the second protocol chip 421b need not particularly be distinguished from each other, each of them is occasionally referred to as the “protocol chip 421.”

The first CHB 420a (first protocol chip 421a) is communicatively connected to the first controller 410a (first CPU 411a) and the second controller 410b (second CPU 411b) via a PCI (Peripheral Component Interconnect) bus 431 and the first PCI switch 430a.

The second CHB 420b (second protocol chip 421b) is communicatively connected to the first controller 410a (first CPU 411a) and the second controller 410b (second CPU 411b) via the PCI (Peripheral Component Interconnect) bus 431 and the second PCI switch 430b.

The PCI bus 431 between the first protocol chip 421a and the first controller 410a (first CPU 411a) is occasionally referred to as the “first communication path.”

The PCI bus 431 between the second protocol chip 421b and the second controller 410b (second CPU 411b) is occasionally referred to as the “second communication path.”

The PCI bus 431 between the first protocol chip 421a and the second controller 410b (second CPU 411b) is occasionally referred to as the “third communication path.”

The PCI bus 431 between the second protocol chip 421b and the first controller 410a (first CPU 411a) is occasionally referred to as the “fourth communication path.”

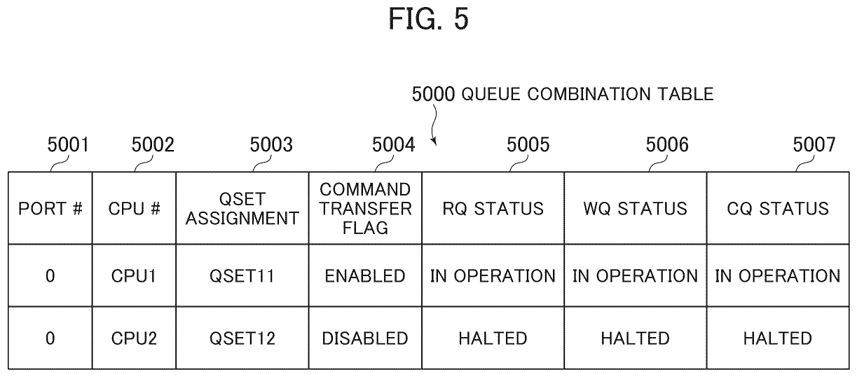

The first PCI switch 430a is configured to be able to switch the communication path for I/O commands received by the first protocol chip 421a between the first communication path and the third communication path. The first protocol chip 421a references a queue combination table 5000 (FIG. 5), and issues an instruction to the first PCI switch 430a to indicate the I/O command to be sent and the destination of the I/O command (first CPU 411a (communication path)). In accordance with the instruction, the first PCI switch 430a switches the communication path for I/O commands between the first communication path and the third communication path.

The second PCI switch 430b is configured to be able to switch the communication path for I/O commands received by the second protocol chip 421b between the second communication path and the fourth communication path. The second protocol chip 421b references the queue combination table 5000, and issues an instruction to the second PCI switch 430b to indicate the I/O command to be sent and the destination of the I/O command (second CPU 411b (communication path)). In accordance with the instruction, the second PCI switch 430b switches the communication path for I/O commands between the first communication path and the third communication path.

The drive box 500 is equipped with a plurality of drives 501, such as SSDs and HDDs, and an ENC (drive enclosure) 502. The drives 501 mounted in the drive box 500 form a plurality of volumes that are used as logical recording areas targeted by the I/O requests from the host server 100.

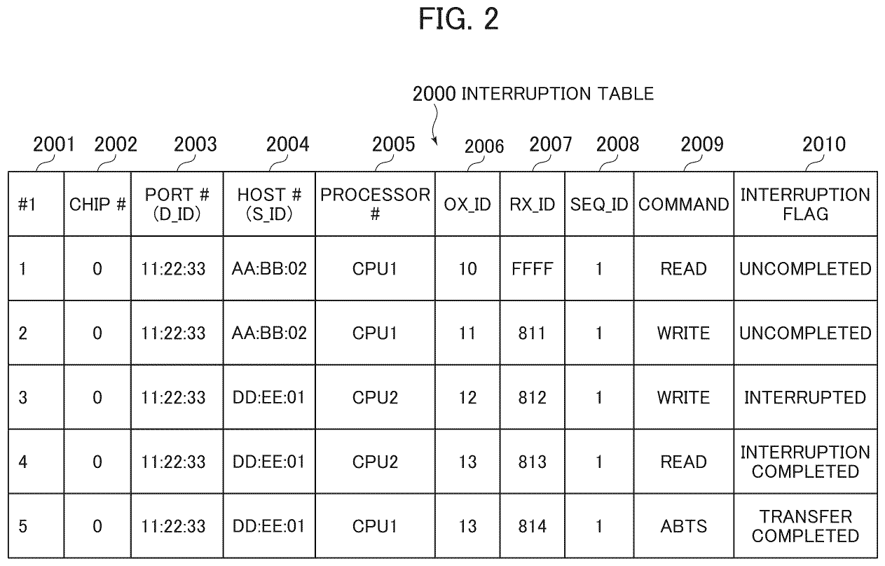

FIG. 2 is a diagram illustrating an interruption table 2000. The interruption table 2000 is stored in the DIMM 412. As illustrated in FIG. 2, the interruption table 2000 includes information (value) storage columns, namely, #1 2001, Chip #2002, Port #2003, Host #2004, Processor #2005, OX_ID 2006, RX_ID 2007, SEQ_ID 2008, Command 2009, and Interruption Flag 2010. In the interruption table 2000, pieces of information, which correspond to individual columns regarding I/Os that were interrupted on the side toward the first CPU 411a upon completion of a queue switching process, are associated with each other and stored as row-by-row information (records).

Specifically, #1 2001 stores an identification number for identifying each row (record). Chip #2002 stores an identification number for identifying the protocol chip 421. Port #2003 stores an identifier for identifying a port owned by the CHB 420. Host #2004 stores an identifier for identifying the host server 100 (the port of the host server 100). Processor #2005 stores the name of the processor (CPU 411) for identifying the processor (CPU 411). OX_ID 2006 stores an exchange ID that is assigned by the host server 100 to one I/O command. RX_ID 2007 stores an exchange ID that is assigned by the protocol chip 421 to one I/O command. SEQ_ID 2008 stores an identifier of a sequence specifying a frame group that is being exchanged between the protocol chip 421 and the host server 100. Command 2009 stores the type of an I/O command. Interruption Flag 2010 stores information (flag) indicating an I/O execution state.

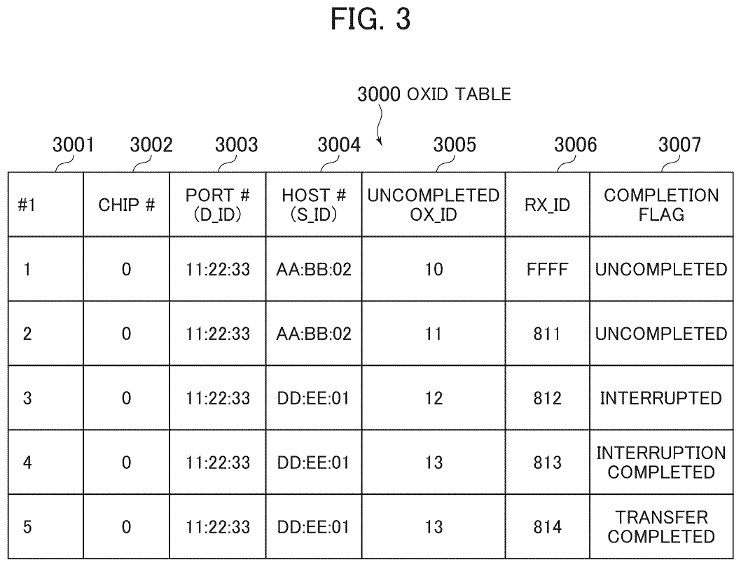

FIG. 3 is a diagram illustrating an OXID table 3000. The OXID table 3000 is stored in an internal memory built in the protocol chip 421. As illustrated in FIG. 3, the OXID table 3000 includes information (value) storage columns, namely, #1 3001, Chip #3002, Port #3003, Host #3004, Uncompleted OX_ID 3005, RX_ID 3006, and Completion Flag 3007. In the OXID table 3000, as the information (value) storage columns, pieces of information, which correspond to individual columns regarding I/Os remaining after the start of the queue switching process, are associated with each other and stored as row-by-row information (records). The remaining I/Os are I/Os that are in progress (being processed) in a queue before queue switching.

Specifically, #1 3001 stores an identification number for identifying each row (record). Chip #3002 stores an identification number for identifying the protocol chip 421. Port #3003 stores an identifier for identifying a port owned by the CHB 420. Host #3004 stores an identifier for identifying the host server 100 (the port of the host server 100). Uncompleted OX_ID 3005 stores an exchange ID that is assigned by the host server 100 to one I/O command. RX_ID 3006 stores an exchange ID that is assigned by the protocol chip 421 to one I/O command. Completion Flag 3007 stores information (flag) indicating the I/O completion status. Uncompleted indicates a state where the corresponding I/O is not completed. Interrupted indicates that the corresponding I/O is interrupted. Interruption Completed indicates that the corresponding interrupted I/O is completed. Transfer Completed indicates that the data transfer of the corresponding I/O is ended, and that the exchange is in a completed state, and further that the I/O control information (I/O resource) is released.

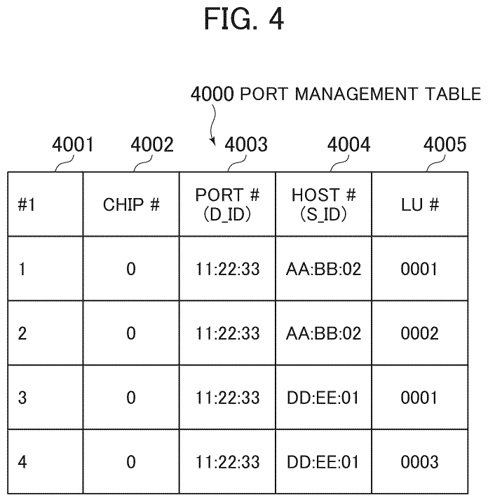

FIG. 4 is a diagram illustrating a port management table 4000. The port management table 4000 is stored in the DIMM 412 on the side of the CPU 411 in which the target port exists. As illustrated in FIG. 4, the port management table 4000 includes information (value) storage columns, namely, #1 4001, Chip #4002, Port #4003, Host #4004, and LU #4005.

In the port management table 4000, as the information (value) storage columns, pieces of information, which correspond to individual columns regarding the correspondence between the host server 100, the ports, and the drive 501 accessible by the host server 100, are associated with each other and stored as row-by-row information (records). Specifically, #1 4001 stores an identification number for identifying each row (record). Chip #4002 stores an identification number for identifying the protocol chip 421. Port #4003 stores an identifier for identifying a port owned by the CHB 420. Host #4004 stores an identifier for identifying the host server 100. LU #4005 stores the logical unit number of a volume accessible by the corresponding host server 100.

When performing I/O control, the protocol chip 421 manages, on an individual port basis, the port (S_ID) of the host server 100 connected to the local port (D_ID) and the assignment of the logical unit numbers of the volumes accessible by the host server 100. The CPU 411 uses the port management table 4000 to retain the correspondence between the ID of the host server 100, the ID of the local port, and the logical unit numbers of the volumes. The CPU 411 performs I/O operations by using control information retained in the port management table 4000. It should be noted that, when a conventional technology is used, the local port will stop (the path on the side of the controller 410 performing an OS update will stop). Therefore, it is necessary to switch the port ID assigned to the host server 100 from a port ID corresponding to the first controller 410a to a port ID corresponding to the second controller 410b before starting the OS update. Meanwhile, in the present embodiment, the paths on the side of the controller 410 performing the OS update are stopped, but the paths on the side of the controller 410 not performing the OS update are not stopped. Therefore, the correspondence between the port ID and the ID of the host server 100 can be maintained. Consequently, there is no need to switch the port ID assigned to the host server 100.

FIG. 5 is a diagram illustrating a queue combination table 5000. The queue combination table 5000 is stored in the internal memory built in the protocol chip 421. It should be noted that the queue combination table 5000 depicted in FIG. 5 is stored in the internal memory of the first protocol chip 421a. The queue combination table 5000 is occasionally referred to as the “queue control information.”

As illustrated in FIG. 5, the queue combination table 5000 includes information (value) storage columns, namely, Port #5001, CPU #5002, Qset Assignment 5003, Command Transfer Flag 5004, RQ Status 5005, WQ Status 5006, and CQ Status 5007. In the queue combination table 5000, as the information (value) storage columns, pieces of information, which correspond to individual columns regarding the correspondence between the CPU 411 and the Qset to be assigned to the CPU 411 and the destination of the I/O command, are associated with each other and stored as row-by-row information (records). Specifically, Port #5001 stores the identifier of a port owned by the CHB 420. CPU #5002 stores the name of the CPU 411 that identifies the CPU 411. Qset Assignment 5003 stores the name of a Qset assigned to the CPU 411. Command Transfer Flag 5004 stores information (“Enabled” or “Disabled”) indicating whether or not the transfer of a command to the corresponding Qset is permitted. RQ Status 5005 stores information indicating the operating status of the RQ of the corresponding Qset. WQ Status 5006 stores information indicating the operating status of the WQ of the corresponding Qset. CQ Status 5007 stores information indicating the operating status of the CQ of the corresponding Qset.

### Overview

### Basic Operation

First of all, I/O control, which is a basic operation performed by the protocol chip 421 and the CPU 411 of the controller 410, will be described in order to facilitate the understanding of the present invention. The protocol chip 421 has a receive queue buffer. The receive queue buffer is an area for temporarily storing data, and is located in the internal memory built in the protocol chip 421. The protocol chip 421 uses the receive queue buffer to temporarily store an I/O command received from the host server 100. Queue control is exercised for control communication with the protocol chip 421 and the CPU 411 in order to exchange the I/O control information. The protocol chip 421 and the CPU 411 exercise I/O control by using the Qset assigned to them. The Qset includes the RQ, the WQ, and the CQ. The RQ receives the notification of an I/O command asynchronously with the protocol chip 421. The WQ is a message send queue that makes an I/O execution request. The CQ is a message receive queue that receives a message indicating the completion of an I/O data transfer initiated in response to the I/O execution request.

The protocol chip 421 monitors the RQ. When there is a vacancy in the RQ, the protocol chip 421 loads an I/O command stored in the receive queue buffer into the RQ. The CPU 411 of the controller 410 monitors the RQ, retrieves and processes an I/O command queued (retained) in the RQ, and thus interprets the I/O command and initiates an I/O transfer request.

The CPU 411 of the controller 410 monitors the WQ. When there is a vacancy in the WQ, the CPU 411 of the controller 410 loads the initiated I/O transfer request into the WQ, and stores the data targeted by the I/O transfer request in a data buffer. The data buffer is a storage area for temporarily storing data, and is disposed, for example, in the DIMM 412.

The protocol chip 421 monitors the WQ, retrieves and processes an I/O transfer request queued (retained) in the WQ, and thus receives the I/O transfer request.

Upon receiving the I/O transfer request, the protocol chip 421 performs a data transfer. In response to the I/O transfer request, data is transferred from the host server 100 to the protocol chip 421, or transferred from the protocol chip 421 to the host server 100 (the present example indicates a case where the data is transferred from the protocol chip 421 to the host server 100).

The protocol chip 421 monitors the CQ. When an I/O transfer is completed, the protocol chip 421 loads a notification of the completion of the I/O transfer into the CQ. It should be noted that, for one I/O transfer request, the notification of one I/O transfer completion is loaded into the CQ. The CPU 411 monitors the CQ, and receives a notification of the completion of I/O transfer by acquiring such a notification from the CQ. The I/O control for processing one I/O command is now completed.

### Operation Overview

Referring to FIGS. 6 to 12, an example will now be described in which the first CPU 411a is halted in response to an instruction from the first controller 410a, and the Qset for sending an I/O command received by the first protocol chip 421a is switched from Qset 11 to Qset 12. Such Qset switching is performed when the SMP OS running on the CPU 411 is to be updated. In the CPU 411 in the SMP OS, one OS runs on a plurality of cores. When the OS is to be updated, it is necessary to simultaneously halt the plurality of cores of the CPU 411 because the protocol chip 421 and the controller 410 are connected in a one-to-one relationship. When the CPU 411 comes to a complete halt, no CPU core is in charge of I/O processing. As a result, no core will be in charge of I/O processing. Further, the queue becomes unavailable, resulting in the loss of I/O control information stored in the queue. Moreover, all I/O commands received from the host server 100 by the protocol chip 421 while the CPU 411 is halted will possibly be lost. Therefore, in a case where the first CPU 411a of the first controller 410a is to be brought to a complete halt in order to update the SMP OS, the queue used for I/O control is switched from a queue assigned to the first CPU 411a, which is to be halted, to a queue assigned to the second CPU 411b of the second controller 410b, which is a different controller not halted, in response to an instruction from the first controller 410a.

FIG. 6 is a diagram illustrating how I/O control is exercised before queue switching. It should be noted that, Nport ID, which is depicted in FIG. 6, is the above-mentioned port D_ID.

Qset 11 and Qset 22 are created in the first memory 412a of the first controller 410a. Qset 11 and Qset 22 are assigned to the first CPU 411a. Qset 11 is associated with the first protocol chip 421a, and Qset 22 is associated with the second protocol chip 421b.

Qset 21 and Qset 12 are created in the second memory 412b of the second controller 410b. Qset 21 and Qset 12 are assigned to the second CPU 411b. Qset 21 is associated with the second protocol chip 421b, and Qset 12 is associated with the first protocol chip 421a.

Qset 11 includes CQ 1, RQ 1, WQ 1. Qset 11 is referred to as the first hot queue set, and the queues included in Qset 11 are referred to as the first hot queues. Qset 12 includes CQ 2, RQ 2, and WQ 2. Qset 12 is referred to as the first standby queue set, and the queues included in Qset 12 are referred to as the first standby queues. In a case where the first CPU 411a is not halted, the first hot queue set is used to process I/O commands received by the first protocol chip 421a by exercising I/O control with respect to the first CPU 411a. In a case where the first CPU 411a is halted, the first standby queue set is used to process I/O commands received by the first protocol chip 421a by exercising I/O control between the first protocol chip 421a and the second CPU 411b.

Qset 21 includes CQ 1, RQ 1, and WQ 1. Qset 21 is referred to as the second hot queue set, and the queues included in Qset 21 are referred to as the second standby queues. Qset 22 includes CQ 2, RQ 2, and WQ 2. Qset 22 is referred to as the second standby queue set, and the queues included in Qset 22 are referred to as the second standby queues.

In a case where the second CPU 411b is not halted, the second hot queue set is used to process I/O commands received by the second protocol chip 421b by exercising I/O control between the second protocol chip 421b and the second CPU 411b. In a case where the second CPU 411b is halted, the second standby queue set is used to process I/O commands received by the second protocol chip 421b by exercising I/O control between the second protocol chip 421b and the first CPU 411a.

In a case where the first hot queue set and the second hot queue set need not particularly be distinguished from each other, each of them is occasionally referred to as the “hot queue set.” In a case where the first hot queues and the second hot queues need not particularly be distinguished from each other, both of them are occasionally referred to as the “hot queues.” In a case where the first standby queue set and the second standby queue set need not particularly be distinguished from each other, each of them is occasionally referred to as the “standby queue set.” In a case where the first standby queues and the second standby queues need not particularly be distinguished from each other, both of them are occasionally referred to as the “standby queues.”

Before switching from Qset 11, which processes the I/O commands received by the first protocol chip 421a, to Qset 12, the first protocol chip 421a monitors RQ 1 of Qset 11. When there is a vacancy in RQ 1, the first protocol chip 421a loads I/O commands accumulated in the receive queue buffer into RQ 1. The first CPU 411a monitors RQ 1, retrieves and processes an I/O command queued (retained) in RQ 1, and thus initiates an I/O transfer request.

The first CPU 411a monitors WQ 1 of Qset 11. When there is a vacancy in WQ 1, the first CPU 411a loads the initiated I/O transfer request into WQ 1. The first protocol chip 421a monitors WQ 1 of Qset 11, retrieves and processes an I/O transfer request queued (retained) in WQ 1, and thus receives the I/O transfer request. Upon receiving the I/O transfer request, the first protocol chip 421a performs a data transfer.

The first protocol chip 421a monitors CQ 1 of Qset 11. When the data transfer is completed, the first protocol chip 421a loads a notification of the completion of I/O transfer into CQ 1. The first CPU 411a monitors CQ 1 of Qset 11, and receives the notification of the completion of I/O transfer by acquiring such a notification. One I/O control operation is now completed.

The second protocol chip 421b monitors RQ 1 of Qset 21. When there is a vacancy in RQ 1, the second protocol chip 421b loads I/O commands accumulated in the receive queue buffer into RQ 1. The second CPU 411b monitors RQ 1 of Qset 21, retrieves and processes an I/O command queued (retained) in RQ 1, and thus initiates an I/O transfer request.

The second CPU 411b monitors WQ 1 of Qset 21. When there is a vacancy in WQ 1, the second CPU 411b loads the initiated I/O transfer request into WQ 1. The second protocol chip 421b monitors WQ 1 of Qset 21, retrieves and processes an I/O transfer request queued (retained) in WQ 1, and thus receives the I/O transfer request. Upon receiving the I/O transfer request, the second protocol chip 421b performs a data transfer.

The second protocol chip 421b monitors CQ 1. When the data transfer is completed, the second protocol chip 421b loads a notification of the completion of I/O transfer into CQ 1. The second CPU 411b monitors CQ 1 of Qset 21, and receives the notification of the completion of I/O transfer by acquiring such a notification. One I/O control operation is now completed.

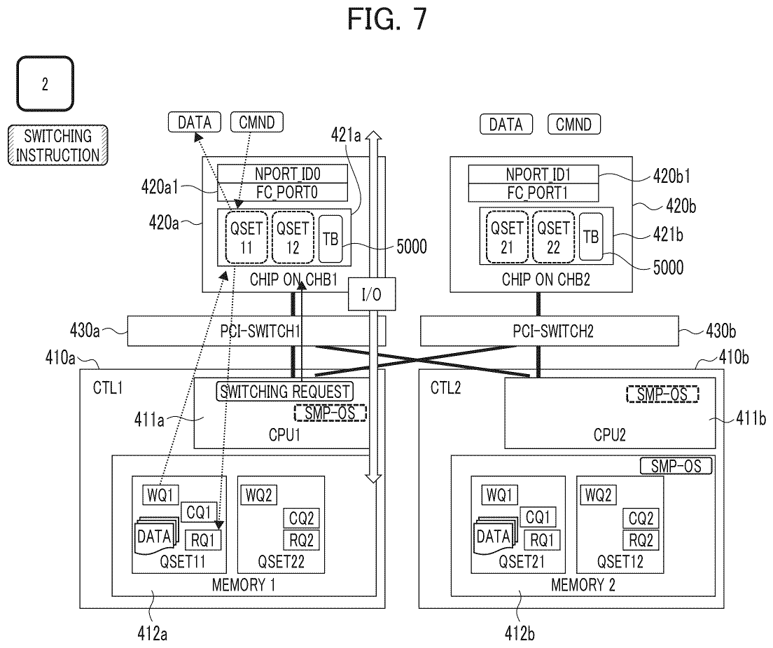

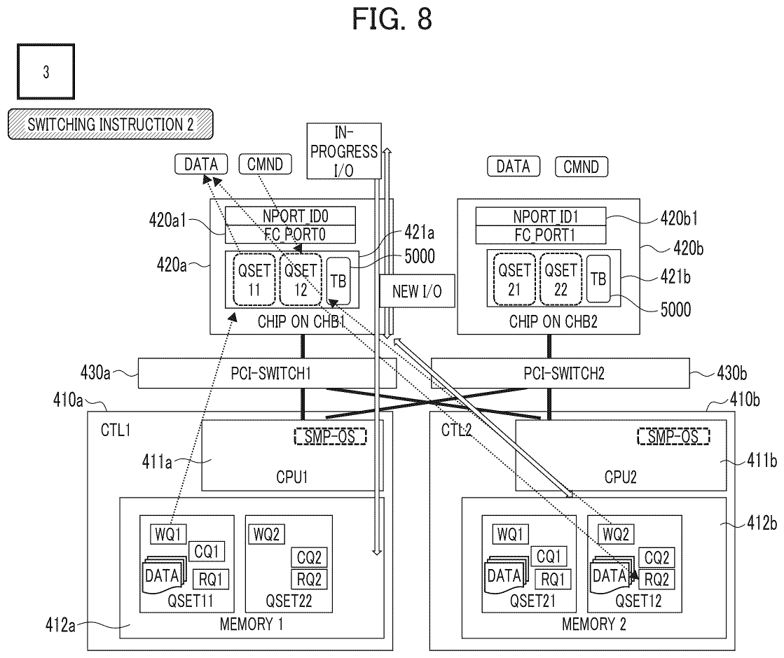

FIG. 7 is a diagram illustrating how control is exercised to issue a switching instruction for queue switching. The second CPU 411b issues a halt start instruction to the first CPU 411a. Upon receiving the halt start instruction, the first CPU 411a sends a Qset switching instruction to the first protocol chip 421a. The first protocol chip 421a updates the queue combination table 5000 so as to change the command transfer flag 5004 corresponding to the first CPU 411a in the queue combination table 5000 from Enabled to Disabled, and to change the command transfer flag 5004 corresponding to the second CPU 411b from Disabled to Enabled. In this instance, the second protocol chip 421b uses Qset 21 to process the I/O command received by the second protocol chip 421b as described above (the same applies to the following FIGS. 8 to 12).

FIG. 8 is a diagram illustrating how control is exercised after the issuance of the switching instruction for queue switching. When the first protocol chip 421a updates the queue combination table 5000, the destination of the I/O command switches from Qset 11 to Qset 12 (i.e., the destination switches from the first CPU 411a to the second CPU 411b), and the I/O command received by the first protocol chip 421a is processed by Qset 12. Specifically, the first protocol chip 421a monitors RQ 2 of Qset 12. When there is a vacancy in RQ 2, the first protocol chip 421a loads I/O commands accumulated in the receive queue buffer into RQ 2. The second CPU 411b monitors RQ 2, retrieves and processes an I/O command queued (retained) in RQ 2 of Qset 12, and thus initiates an I/O transfer request. The second CPU 411b monitors WQ 2 of Qset 12. When there is a vacancy in WQ 2, the second CPU 411b loads the initiated I/O transfer request into WQ 2.

The first protocol chip 421a monitors WQ 2 of Qset 12, retrieves and processes an I/O transfer request queued (retained) in WQ 2, and thus receives the I/O transfer request. Upon receiving the I/O transfer request, the first protocol chip 421a performs a data transfer.

The first protocol chip 421a monitors CQ 2 of Qset 12. When the data transfer is completed, the first protocol chip 421a loads a notification of the completion of I/O transfer into CQ 2. The second CPU 411b monitors CQ 2 of Qset 12, and receives the notification of the completion of I/O transfer by acquiring such a notification. Control of one I/O is now completed.

Before Qset 11 comes to a halt, it is necessary to complete any outstanding I/O control (in-progress I/O (remaining I/O)) in Qset 11. Therefore, it is necessary to process queue elements (queue information) loaded into Qset 11 before Qset 11 comes to a halt. Consequently, the first protocol chip 421a monitors WQ 1 of Qset 11, retrieves and processes an I/O transfer request queued (retained) in WQ 1, and thus receives the I/O transfer request. Upon receiving the I/O transfer request, the first protocol chip 421a performs a data transfer.

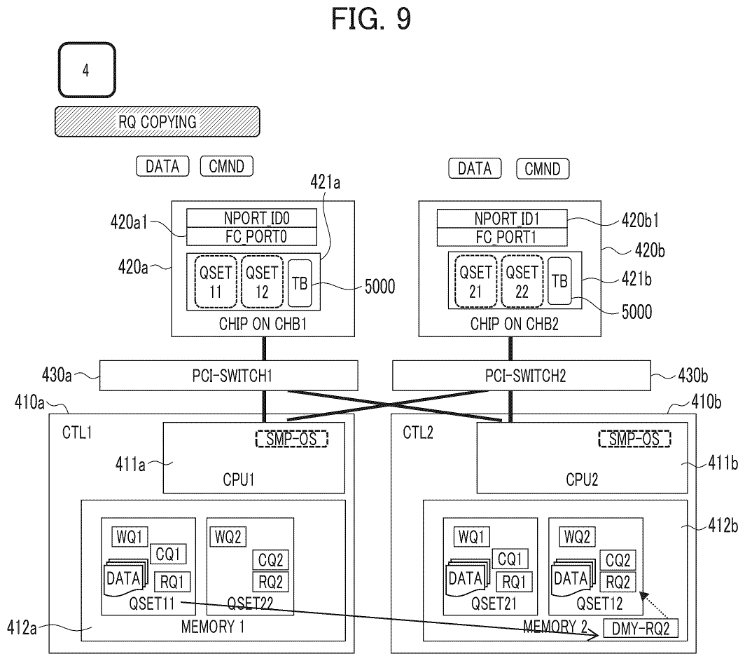

FIG. 9 is a diagram illustrating how control is exercised after the issuance of the switching instruction for queue switching. The first CPU 411a copies data in RQ 1 to DMY RQ 2 in the second memory 412b of the second controller 410b.

The second CPU 411b monitors DMY RQ 2 and RQ 2 of Qset 12, retrieves and processes I/O commands queued (retained) in DMY RQ 2 and RQ 2, and thus initiates an I/O transfer request. In this instance, the second CPU 411b preferentially processes an I/O command for a remaining in-progress I/O by preferentially retrieving and processing I/O commands queued (held) in DMY RQ 2 over I/O commands queued in RQ 2.

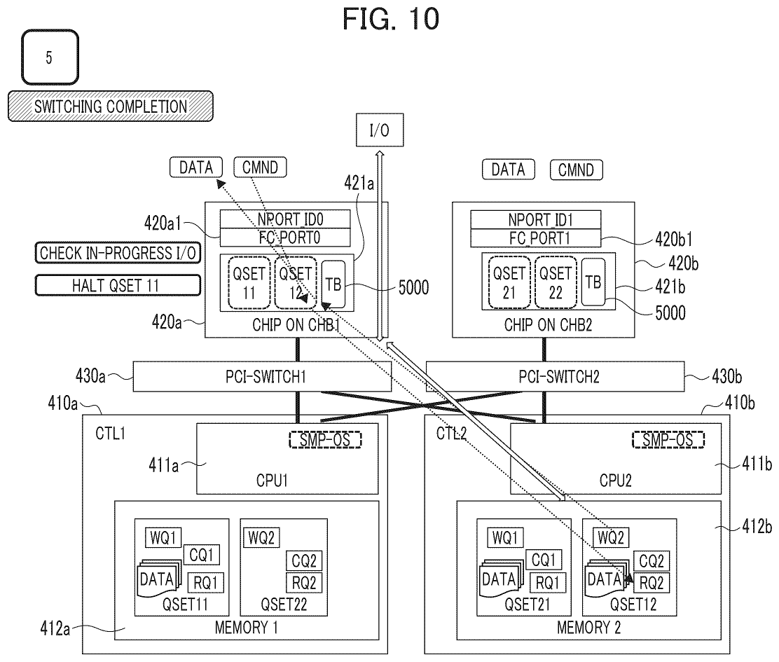

FIG. 10 is a diagram illustrating how control is exercised after the issuance of the switching instruction for queue switching. The first protocol chip 421a checks the status of an in-progress I/O, and halts Qset 11.

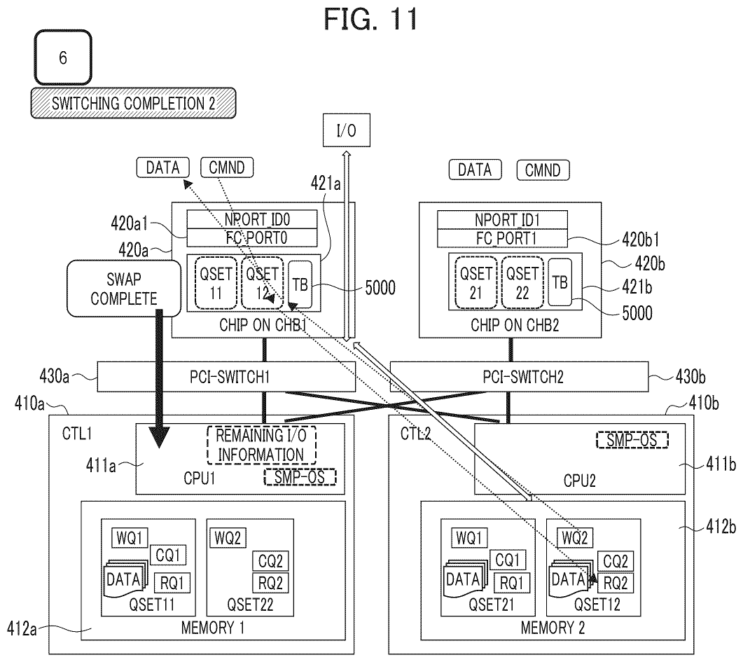

FIG. 11 is a diagram illustrating how control is exercised after the issuance of the switching instruction for queue switching. The first protocol chip 421a notifies the first CPU 411a of the completion of queue switching (Swap complete). Upon receiving the notification of the completion of queue switching, the first CPU 411a creates remaining I/O information. Depending on the situation of I/O (external factors), the notification of the completion of I/O transfer may not be sent from the first protocol chip 421a or a delay of 10 seconds or more may occur. A simple wait for a certain period of time makes it impossible to start an OS update during that period of time. This will result in an increase in the time for update. Therefore, an I/O remaining unprocessed at the time of reception of a switching completion notification is interrupted, and the remaining I/O information regarding the interrupted remaining I/O is sent to the second controller 410b as interruption target information. This will suppress an increase in the time for update.

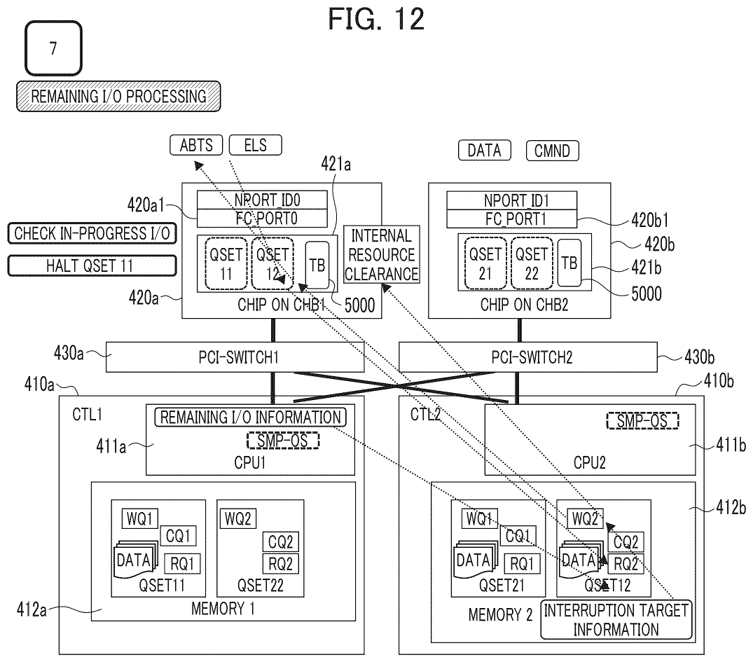

FIG. 12 is a diagram illustrating how control is exercised after completion of queue switching. The first CPU 411a transfers and adds the remaining I/O information to the interruption target information in the second memory 412b of the second controller 410b. Subsequently, the second CPU 411b issues an interruption transfer request instruction to the first protocol chip 421a via Qset 12. The first protocol chip 421a references the interruption target information, and clears an internal resource corresponding to the remaining I/O. The internal resource is the I/O control information retained in the protocol chip 421. For each I/O, the internal resource for the control of one I/O is generated and used to perform an I/O transfer. The protocol chip 421 secures and executes such an I/O resource when executing the I/O transfer, and releases the I/O resource after completion of I/O transfer. The resource is limited in number by the internal memory capacity of the protocol chip 421. If the I/O transfer is interrupted, the resource remains in the protocol chip 421, and if the resource is continuously consumed, new resources cannot be secured so that the I/O operation comes to a halt (stalls). Therefore, when the I/O resource is interrupted, the CPU 411 needs to perform an interruption process on the protocol chip 421 to release the I/O resource in the protocol chip 421.

### Specific Operation

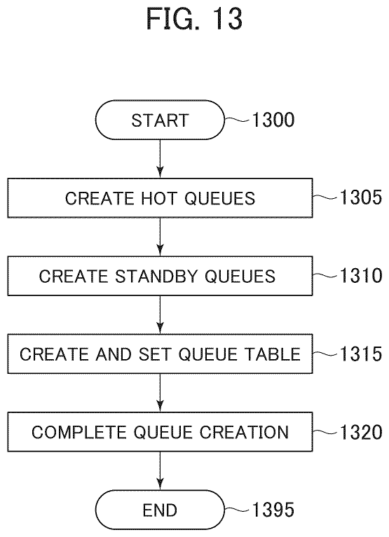

FIG. 13 is a flowchart illustrating the flow of a queue creation process that is performed by the CPU 411. The CPU 411 executes the flow of the queue creation process at the timing of initial setup/initial startup to create the queues (RQ, CQ, and WQ) in the DIMM 412. The CPU 411 begins the queue creation process by performing step 1300 of FIG. 13. After completion of steps 1300 to 1320, which are described below, the CPU 411 proceeds to step 1395 to temporarily end the flow of the queue creation process.

In step 1305, the CPU 411 creates the hot queues (hot queue set).

In step 1310, the CPU 411 creates the standby queues (standby queue set).

In step 1315, the CPU 411 creates the queue combination table 5000, and sets (stores) the created queue combination table 5000 in the internal memory of the protocol chip 421.

In step 1320, the CPU 411 completes the creation of the queues.

It should be noted that, when a conventional technology is used, each time the queue set for sending an I/O command received by the first protocol chip 421a is switched from a queue set assigned to the first CPU 411a to a queue set assigned to the second CPU 411b, it is necessary to recreate the queues and change the queue address settings. Meanwhile, in the present embodiment, the queue set can be switched by updating the queue combination table. Therefore, only one setting process (the process described in FIG. 13) is required. There is no need to recreate the queues or change the queue address settings each time switching is required.

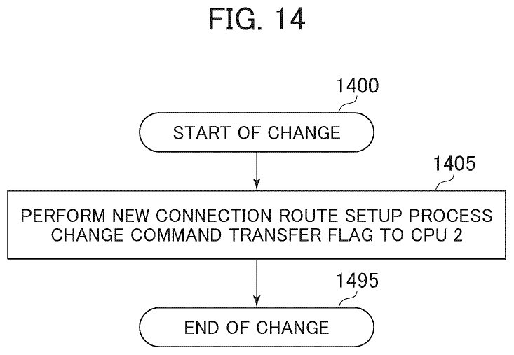

FIG. 14 is a flowchart illustrating the flow of a process that is performed by the first protocol chip 421a to update the queue combination table 5000 through the use of FW (firmware) included in the first protocol chip 421a. Upon receiving a Qset switching instruction from the CPU 411, the first protocol chip 421a begins the process by performing step 1400 of FIG. 14, proceeds to step 1405, and performs a new connection route setup process for I/O commands by updating the queue combination table 5000. Specifically, upon receiving the Qset switching instruction from the first CPU 411a, the first protocol chip 421a changes the command transfer flag 5004 corresponding to the first CPU 411a from Disabled to Enabled, and changes the command transfer flag 5004 corresponding to the second CPU 411b from Enabled to Disabled.

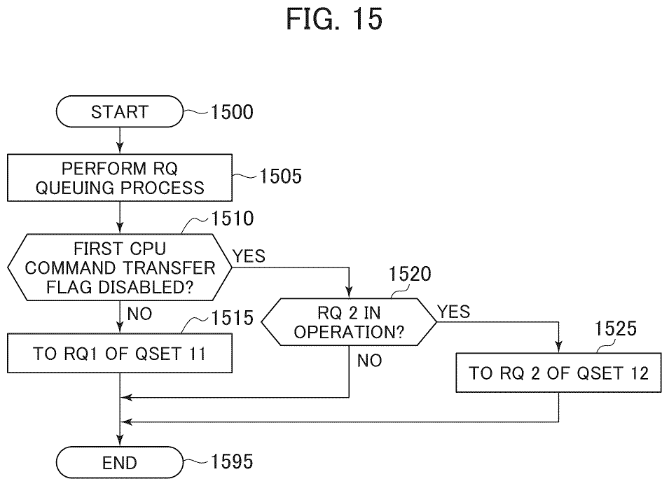

FIG. 15 is a flowchart illustrating the flow of an RQ queuing process that is performed by the first protocol chip 421a through the use of FW. The first protocol chip 421a starts processing in step 1500 of FIG. 15, proceeds to step 1505 to start the RQ queuing process, and then proceeds to step 1510.

In step 1510, the first protocol chip 421a checks the queue combination table 5000 to determine whether the command transfer flag 5004 corresponding to the first CPU 411a is Disabled.

If the command transfer flag 5004 corresponding to the first CPU 411a is not Disabled (i.e., is Enabled), the first protocol chip 421a answers “NO” to the query in step 1510, and proceeds to step 1515. In step 1515, depending on the vacancy in RQ 1 of Qset 11, the first protocol chip 421a loads an I/O command retained in the receive queue buffer into RQ 1. Subsequently, the first protocol chip 421a proceeds to step 1595 to temporarily end the flow of the RQ queuing process.

If the command transfer flag 5004 corresponding to the first CPU 411a is Disabled, the first protocol chip 421a answers “YES” to the query in step 1510, and proceeds to step 1520 to determine whether RQ Status 5005 corresponding to Qset 12 in the queue combination table 5000 (i.e., the operating status of RQ 2) is In Operation.

If RQ Status 5005 corresponding to Qset 12 in the queue combination table 5000 is not In Operation, the first protocol chip 421a answers “NO” to the query in step 1520, and proceeds to step 1595 to temporarily end the flow of the RQ queuing process.

If RQ status 5005 corresponding to Qset 12 in the queue combination table 5000 is In Operation, the first protocol chip 421a answers “YES” to the query in step 1520, and proceeds to step 1525. In step 1525, depending on the vacancy in RQ 2 of Qset 12, the first protocol chip 421a places an I/O command retained in the receive queue buffer in RQ 2.

The second protocol chip 421b also executes the flow of the RQ queuing process similar to that depicted in FIG. 15. The processing flow executed in this case is similar to that depicted in FIG. 15, except that the first CPU 411a is replaced by the second CPU 411b, and that Qset 11 is replaced by Qset 21, and further that Qset 12 is replaced by Qset 22.

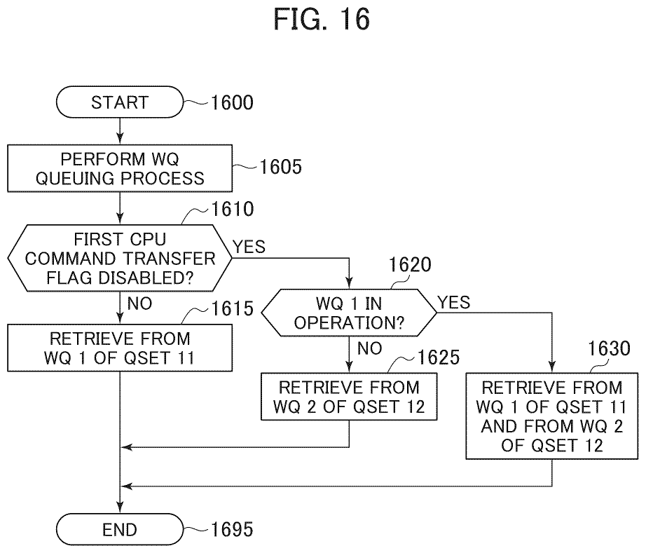

FIG. 16 is a flowchart illustrating the flow of a WQ queuing process that is performed by the first protocol chip 421a through the use of FW. The first protocol chip 421a starts processing in step 1600 of FIG. 16, proceeds to step 1605 to start the WQ queuing process, and then proceeds to step 1610.

In step 1610, the first protocol chip 421a checks the queue combination table 5000 to determine whether the command transfer flag 5004 corresponding to the first CPU 411a is Disabled.

If the command transfer flag 5004 corresponding to the first CPU 411a is not Disabled (i.e., is Enabled), the first protocol chip 421a answers “NO” to the query in step 1610, and proceeds to step 1615. In step 1615, the first protocol chip 421a retrieves an I/O transfer request queued (retained) in WQ 1 of Qset 11 from WQ 1. Subsequently, the first protocol chip 421a proceeds to step 1695 to temporarily end the flow of the WQ queuing process.

If the command transfer flag 5004 corresponding to the first CPU 411a is Enabled, the first protocol chip 421a answers “YES” to the query in step 1610, and proceeds to step 1620 to determine whether WQ Status 5006 corresponding to Qset 11 in the queue combination table 5000 (i.e., the operating status of WQ 1) is In Operation.

If WQ Status 5006 corresponding to Qset 11 in the queue combination table 5000 is not In Operation, the first protocol chip 421a answers “NO” to the query in step 1620, and proceeds to step 1625 to retrieve an I/O transfer request from WQ 2 of Qset 12. Subsequently, the first protocol chip 421a proceeds to step 1695 to temporarily end the flow of the WQ queuing process.

If WQ Status 5006 corresponding to Qset 11 in the queue combination table 5000 is In Operation, the first protocol chip 421a answers “YES” to the query in step 1620, and proceeds to step 1630 to retrieve an I/O transfer request from WQ 1 of Qset 11 and from WQ 2 of Qset 12. This results in retrieving an I/O transfer request remaining in WQ 1 of Qset 11 after the start of the queue switching process and an I/O transfer request for WQ 2 of Qset 12, which is issued by an I/O command sent to Qset 12 after the start of queue switching. Subsequently, the first protocol chip 421a proceeds to step 1695 to temporarily end the flow of the WQ queuing process.

The second protocol chip 421b also executes the flow of the wo queuing process similar to that depicted in FIG. 16. The processing flow executed in this case is similar to that depicted in FIG. 16, except that the first CPU 411a is replaced by the second CPU 411b, and that Qset 11 is replaced by Qset 21, and further that Qset 12 is replaced by Qset 22.

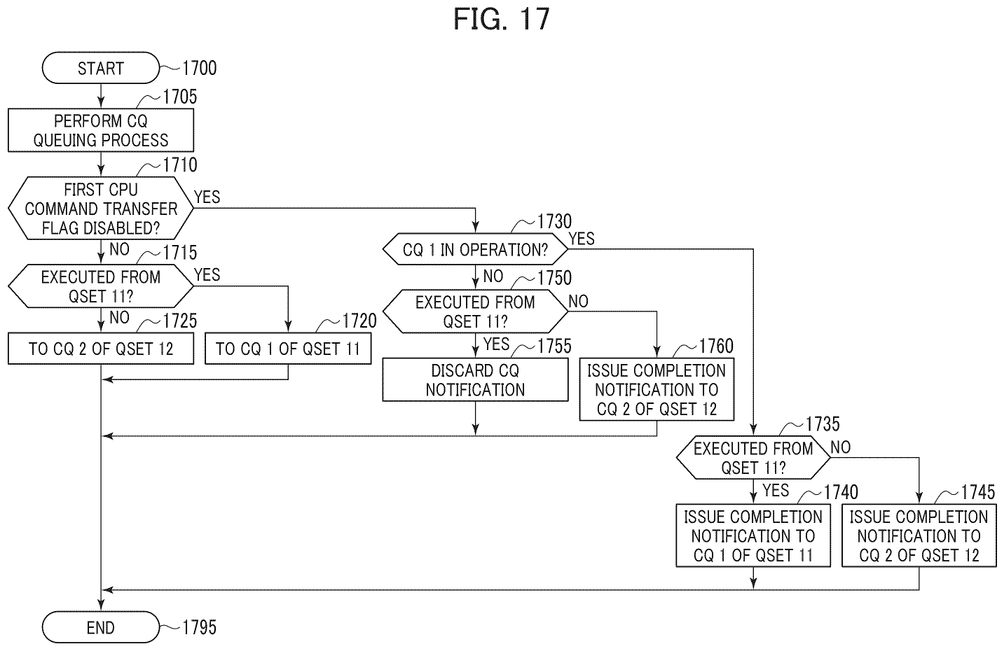

FIG. 17 is a flowchart illustrating the flow of a CQ queuing process that is performed by the first protocol chip 421a through the use of FW. The first protocol chip 421a needs to load an I/O transfer completion into the same Qset as the Qset from which the I/O transfer request was retrieved. If the IO transfer completion is loaded in the CQ of another Qset, an error occurs. The first protocol chip 421a executes the processing flow depicted in FIG. 17 to load the IO transfer completion into the same Qset as the Qset from which the I/O transfer request was retrieved.

The first protocol chip 421a starts processing in step 1700 of FIG. 17, proceeds to step 1705 to start the CQ queuing process, and then proceeds to step 1710.

In step 1710, the first protocol chip 421a determines whether the command transfer flag 5004 corresponding to the first CPU 411a in the queue combination table 5000 is Disabled.

If the command transfer flag 5004 corresponding to the first CPU 411a is not Disabled, the first protocol chip 421a answers “NO” to the query in step 1710, proceeds to step 1715, and determines whether the completed I/O transfer was performed in response to a request from Qset 11.

If the completed I/O transfer was performed in response to a request from Qset 11, the first protocol chip 421a answers “YES” to the query in step 1715, proceeds to step 1720, and loads a notification of I/O transfer completion into CQ 1 of Qset 11. Subsequently, the first protocol chip 421a proceeds to step 1795 to temporarily end the flow of the Co queuing process.

If the completed I/O transfer was not performed in response to a request from Qset 11, the first protocol chip 421a answers “NO” to the query in step 1715, proceeds to step 1725, and loads the notification of I/O transfer completion into CQ 2 of Qset 12. Subsequently, the first protocol chip 421a proceeds to step 1795 to temporarily end the flow of the Co queuing process.

If the command transfer flag 5004 corresponding to the first CPU 411a is Disabled in step 1710, the first protocol chip 421a answers “YES” to the query in step 1710, proceeds to step 1730, and determines whether the status of CQ 1 (CQ Status 5007 corresponding to Qset 11) in the queue combination table 5000 is In Operation.

If the status of CQ 1 (CQ Status 5007 corresponding to Qset 11) in the queue combination table 5000 is In Operation, the first protocol chip 421a answers “YES” to the query in step 1730, proceeds to step 1735, and determines whether the completed I/O transfer was performed in response to a request from Qset 11.

If the completed I/O transfer was performed in response to a request from Qset 11, the first protocol chip 421a answers “YES” to the query in step 1735, proceeds to step 1740, and loads the notification of I/O transfer completion into CQ 1 of Qset 11. Subsequently, the first protocol chip 421a proceeds to step 1795 to end the flow of the co queuing process.

If the completed I/O transfer was not performed in response to a request from Qset 11, the first protocol chip 421a answers “NO” to the query in step 1735, proceeds to step 1745, and loads the notification of I/O transfer completion into CQ 2 of Qset 12.

If the status of CQ 1 (CQ Status 5007 corresponding to Qset 11) in the queue combination table 5000 is not In Operation in step 1730, the first protocol chip 421a answers “NO” to the query in step 1730, proceeds to step 1750, and determines whether the completed I/O transfer was performed in response to a request from Qset 11.

If the completed I/O transfer was performed in response to a request from Qset 11, the first protocol chip 421a answers “YES” to the query in step 1750, and proceeds to step 1755. In step 1755, the first protocol chip 421a discards the notification of I/O transfer completion because the notification of I/O transfer completion cannot be loaded into CQ 1, which needs to be loaded with the notification of I/O transfer completion. Subsequently, the first protocol chip 421a proceeds to step 1795 to temporarily end the flow of the CQ queuing process.

If the completed I/O transfer was not performed in response to a request from Qse1 11, the first protocol chip 421a answers “NO” to the query in step 1750, proceeds to step 1760, and places the notification of I/O transfer completion in CQ 2 of Qset 12. Subsequently, the first protocol chip 421a proceeds to step 1795 to temporarily end the flow of the CQ queuing process.

The second protocol chip 421b also executes the flow of the co queuing process similar to that depicted in FIG. 17. The processing flow executed in this case is similar to that depicted in FIG. 16, except that the first CPU 411a is replaced by the second CPU 411b, and that Qset 11 is replaced by Qset 21, and further that Qset 12 is replaced by Qset 22.

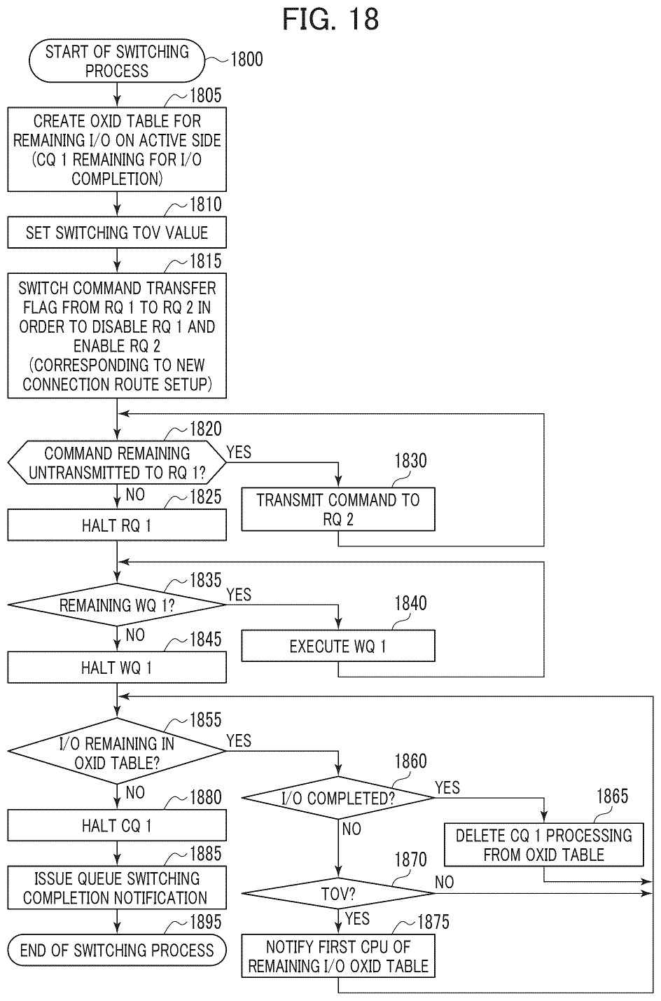

FIG. 18 is a flowchart illustrating the flow of a queue switching process that is performed by the first protocol chip 421a through the use of FW. The first protocol chip 421a starts processing in step 1800 of FIG. 18, then sequentially performs steps 1805 to 1815, which are described below, and proceeds to step 1820.

In step 1805, the first protocol chip 421a creates the OXID table 3000 regarding remaining I/Os on the active side (the side toward the hot queue set to be switched). As described above, the OXID table 3000 is information indicating the status of in-progress I/Os (remaining I/Os) on the side toward the first CPU 411a (the side toward the hot queue set to be switched).

In step 1810, the first protocol chip 421a sets a TOV (Time Out Value) value that is used for switching processing. The TOV value is a threshold for a timer. The timer starts counting when switching processing is started by the queue switching process. When the timer exceeds the TOV value, an I/O in the middle of I/O processing (an uncompleted I/O) is set as an interruption target to end the switching processing. In some cases, the processing of all the remaining I/Os may end (be completed) before the timer exceeds the TOV value.

In step 1815, the first protocol chip 421a switches the command transfer flag 5004 in the queue combination table 5000 from RQ 1 to RQ 2. More specifically, the first protocol chip 421a changes the command transfer flag 5004 corresponding to Qset 11 including RQ 1 in the queue combination table 5000 from Enabled to Disabled, and changes the command transfer flag 5004 corresponding to Qset 12 including RQ 2 from Disabled to Enabled.

The first protocol chip 421a proceeds to step 1820, and determines whether or not there remains an unsent I/O command that is to be sent to RQ 1 of Qset 11.

If any unsent IO command remains before being sent to RQ 1 of Qset 11, the first protocol chip 421a answers “YES” to the query in step 1820, sends the remaining I/O command to RQ 2 of Qset 12, returns to step 1820, and then performs step 1820 again.

If there are no unsent I/O commands remaining before being sent to RQ 1 of Qset 11, the first protocol chip 421a answers “NO” to the query in step 1820, proceeds to step 1825, halts RQ 1 of Qset 11, and then proceeds to step 1835.

In step 1835, the first protocol chip 421a determines whether or not there is an unprocessed I/O transfer request remaining in WQ 1 of Qset 11. If an unprocessed I/O transfer request remains in WQ 1 of Qset 11, the first protocol chip 421a answers “YES” to the query in step 1835, and proceeds to step 1840 to retrieve and execute the unprocessed I/O transfer request. Subsequently, the first protocol chip 421a returns to step 1835, and performs step 1835 again.

If there are no unprocessed I/O transfer requests remaining in WQ 1 of Qset 11, the first protocol chip 421a answers “NO” to the query in step 1835, and proceeds to step 1845, halts WQ 1 of Qset 11, and then proceeds to step 1855.

In step 1855, the first protocol chip 421a references the OXID table 3000 to determine whether there are any remaining I/Os (uncompleted I/Os (i.e., I/Os still not loaded into CQ 1 of Qset 11)).

If there are any remaining I/Os, the first protocol chip 421a answers “YES” to the query in step 1855, and proceeds to step 1860 to determine whether the remaining I/Os have been completed.

If the remaining I/Os are completed, the first protocol chip 421a answers “YES” to the query in step 1860, proceeds to step 1865, places a notification of completion of remaining I/Os in CQ 1, and deletes the information (record) regarding the corresponding remaining I/Os from the OXID table 3000. Subsequently, the first protocol chip 421a returns to step 1855, and performs step 1855 in the manner described above.

If the remaining I/Os are not completed, the first protocol chip 421a answers “NO” to the query in step 1860, proceeds to step 1870, and determines whether the TOV value is exceeded by the timer.

If the TOV value is not exceeded by the timer, the first protocol chip 421a answers “NO” to the query in step 1870, returns to step 1855, and performs step 1855 in the manner described above.

If the TOV value is exceeded by the timer, the first protocol chip 421a answers “YES” to the query in step 1870, proceeds to step 1875, notifies the first CPU 411a of the OXID table 3000 indicating the remaining I/Os, returns to step 1855, and performs step 1855 in the manner described above. In this case, the remaining I/Os are handled as the I/Os to be interrupted. Therefore, when the processing proceeds to step 1855, it is determined that there is no remaining I/Os.

If there are no remaining I/Os in step 1855, the first protocol chip 421a answers “NO” to the query in step 1855, sequentially performs steps 1880 and 1885 described below, and then proceeds to step 1895 to temporarily end the flow of the queue switching process.

In step 1880, the first protocol chip 421a halts CQ 1. At this point of time, all of RQ 1, WQ 1, and CQ 1 of Qset 11 are completely halted.

In step 1885, the first protocol chip 421a notifies the first CPU 411a of the completion of queue switching.

The second protocol chip 421b also executes the flow of the queue switching process similar to that depicted in FIG. 18. The processing flow executed in this case is similar to that depicted in FIG. 18, except that the first CPU 411a is replaced by the second CPU 411b, and that the second CPU 411b is replaced by the first CPU 411a, and further that Qset 11 is replaced by Qset 21, and still further that Qset 12 is replaced by Qset 22.

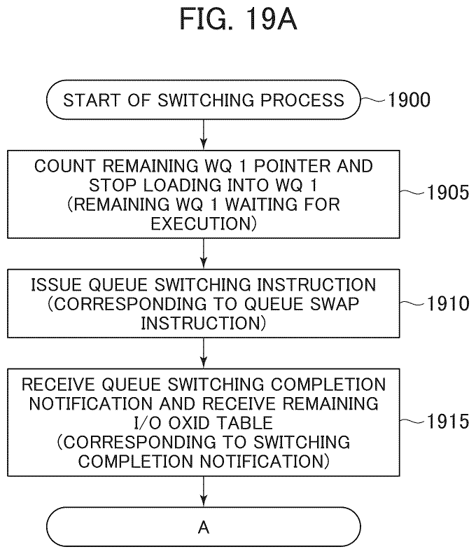

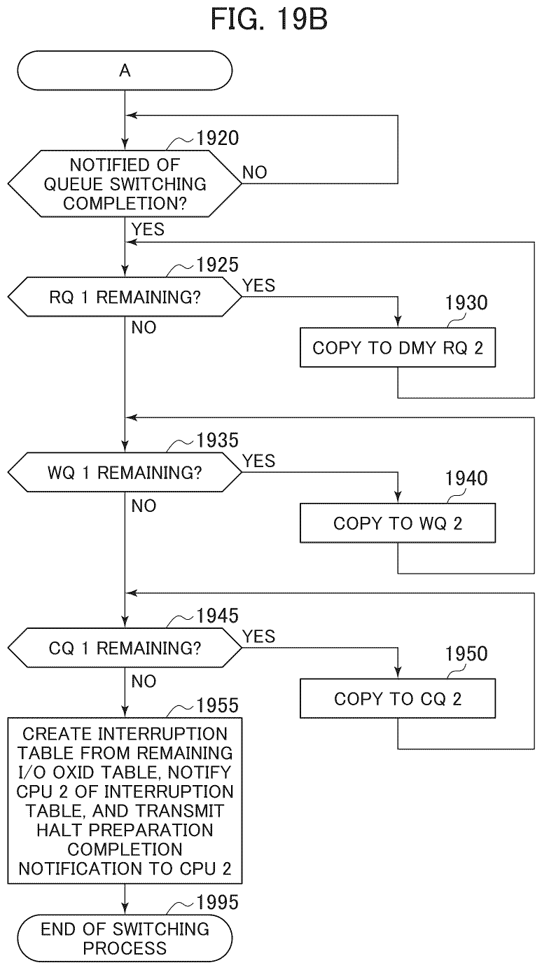

FIGS. 19A and 19B are flowcharts illustrating the flow of the queue switching process that is performed by the first CPU 411a through the use of a program. When the first CPU 411a executes this processing flow, RQ 1, WQ 1 and CQ 1 of Qset 11 are processed not only on the side toward the first protocol chip 421a but also on the side toward the first controller 410a after the notification of queue switching completion (after all of RQ 1, WQ 1 and CQ 1 of Qset 11 are halted).

The first CPU 411a starts the queue switching process in step 1900 of FIG. 19A, sequentially performs steps 1905 to 1915, which are described below, and then proceeds to step 1920.

In step 1905, the first CPU 411a obtains the value of the pointer of WQ 1 in Qset 11 to determine the number of I/O transfer requests that are remaining in WQ 1 and waiting to be executed. The first CPU 411a stops loading new I/O transfer requests into WQ 1 of Qset 11.

In step 1910, the first CPU 411a sends a queue switching instruction to the first protocol chip 421a.

In step 1915, the first CPU 411a receives a queue switching completion notification from the first protocol chip 421a. The first CPU 411a receives the OXID table 3000 indicating the remaining I/Os from the first protocol chip 421a.

The first CPU 411a proceeds to step 1920, and determines whether or not there is the queue switching completion notification. If there is no queue switching completion notification, the first CPU 411a answers “NO” to the query in step 1920, and performs step 1920 again.

If there is the queue switching completion notification, the first CPU 411a answers “YES” to the query in step 1920, proceeds to step 1925, and determines whether or not there is an I/O command remaining in RQ 1 of Qset 11.

If there is an I/O command remaining in RQ 1 of Qset 11, the first CPU 411a answers “YES” to the query in step 1925, proceeds to step 1930, copies the I/O command to DMY RQ 2 of Qset 12, returns to step 1925, and performs step 1925 in the manner described above.

If there is no I/O command remaining in RQ 1 of Qset 11, the first CPU 411a answers “NO” to the query in step 1925, proceeds to step 1935, and determines whether there is an I/O transfer request remaining in WQ 1 of Qset 11.

If there is an I/O transfer request remaining in WQ 1 of Qset 11, the first CPU 411a answers “YES” to the query in step 1935, proceeds to step 1940, copies the I/O transfer request to WQ 2 of Qset 12, and returns to step 1935.

If there are no remaining I/O transfer requests in WQ 1 of Qset 11, the first CPU 411a answers “NO” to the query in step 1935, proceeds to step 1945, and determines whether there are any I/Os remaining in CQ 1 of Qset 11 (notification of completion of transfer of remaining I/Os).

If there is a remaining I/O in CQ 1 of Qset 11 (notification of completion of transfer of remaining I/Os), the first CPU 411a answers “YES” to the query in step 1945, proceeds to step 1950, copies an I/O transfer completion notification from CQ 1 of Qset 11 to CQ 2 of Qset 12, returns to step 1945, and performs step 1945 in the manner described above.

If there is no remaining I/O in CQ 1 of Qset 11 (notification of completion of transfer of remaining I/Os), the first CPU 411a answers “NO” to the query in step 1945, proceeds to step 1955, and creates the interruption table 2000 from the OXID table 3000 indicating the remaining I/Os. The first CPU 411a notifies the second CPU 411b of the interruption table 2000, and sends a halt preparation completion notification to the second CPU 411b.

The second CPU 411b also executes the flow of the queue switching process similar to that depicted in FIGS. 19A and 19B. The processing flow executed in this case is similar to that depicted in FIGS. 19A and 19B, except that the first CPU 411a is replaced by the second CPU 411b, and that the second CPU 411b is replaced by the first CPU 411a, and further that Qset 11 is replaced by Qset 21, and still further that Qset 12 is replaced by Qset 22.

### OS Update

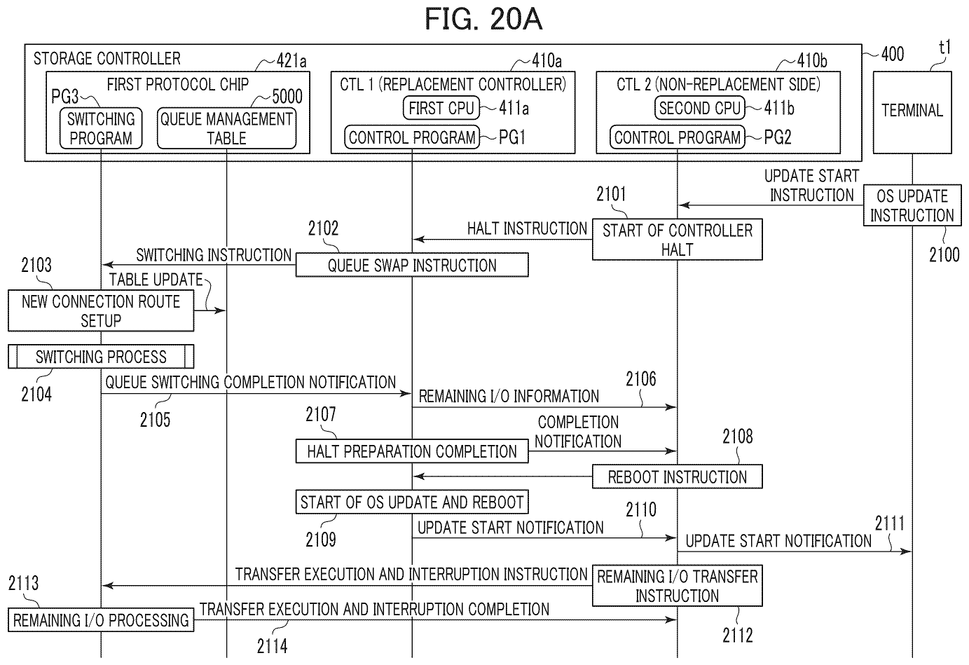

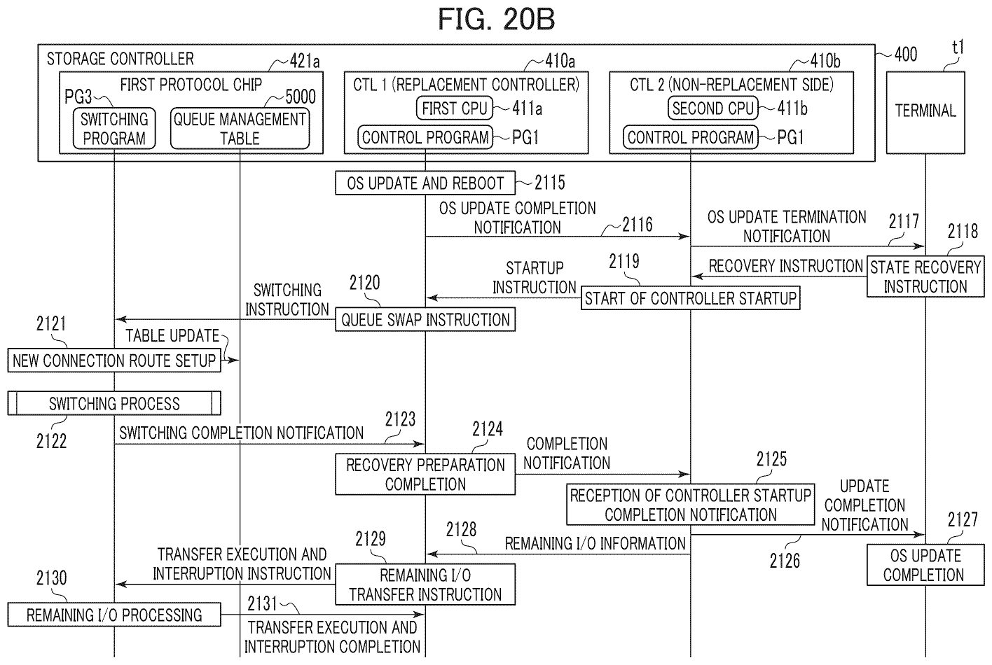

FIGS. 20A and 20B are sequence diagrams illustrating operations performed to update the SMP OS that runs on the first CPU 411a.

The storage system 200 operates as indicated in steps 2100 to 2131 described below. The first CPU 411a performs operations described below by using a control program PG1, the second CPU 411b performs operations described below by using a control program PG2, and the first protocol chip 421a performs operations described below by using a switching program PG3.

In step 2100, a terminal t1 instructs the second CPU 411b to start updating the OS.

In step 2101, the second CPU 411b starts a process of halting the first controller 410a, and sends a halt instruction to the first CPU 411a.

In step 2102, upon receiving the halt instruction from the second CPU 411b, the first CPU 411a sends a queue switching processing instruction (queue swap instruction) to the first protocol chip 421a.

In step 2103, the first protocol chip 421a sets a new connection route (updates the queue combination table 5000).

In step 2104, the first protocol chip 421a performs the queue switching process (the processing flow depicted in the flowchart of FIG. 18).

In step 2105, the first protocol chip 421a sends the queue switching completion notification to the first CPU 411a.

In step 2106, the first CPU 411a sends the remaining I/O information to the second CPU 411b.

In step 2107, upon completion of halt preparation, the first CPU 411a sends a completion notification to the second CPU 411b.

In step 2108, the second CPU 411b sends a reboot instruction to the first CPU 411a.

In step 2109, the first CPU 411a starts an OS update and a reboot.

In step 2110, the first CPU 411a sends an update start notification to the second CPU 411b.

In step 2111, the second CPU 411b sends the update start notification to the terminal t1.

In step 2112, the second CPU 411b sends a remaining I/O transfer instruction (transfer execution and interruption instruction) to the first protocol chip 421a.

In step 2113, the first protocol chip 421a performs a remaining I/O processing.

In step 2114, the first protocol chip 421a transfers the queue elements to the second controller 410b, and notifies the second CPU 411b of interruption completion.

In step 2115, the first CPU 411a executes the OS update and the reboot.

In step 2116, the first CPU 411a sends an OS update completion notification to the second CPU 411b.

In step 2117, the second CPU 411b sends an OS update termination notification to the terminal t1.

In step 2118, the terminal t1 sends a state recovery instruction to the second CPU 411b.

In step 2119, the second CPU 411b instructs the first CPU 411a to initiate a controller startup sequence.

In step 2120, the first CPU 411a sends the queue switching processing instruction (queue swap instruction) to the first protocol chip 421a.

In step 2121, the first protocol chip 421a performs new connection route setup (updates the queue combination table 5000).

In step 2122, the first protocol chip 421a performs the queue switching process (Qset 12→Qset 11) in which Oset switching is reversed with respect to the processing flow depicted in the flowchart of FIG. 18. The processing flow executed in this case is similar to that depicted in FIG. 18, except that the first CPU 411a and the second CPU 411b are interchanged, and that Qset 11 and the queues included in Qset 11 and Qset 12 and the queues included in Qset 12 are interchanged.

In step 2123, the first protocol chip 421a sends the queue switching completion notification to the first controller 410a.

In step 2124, the first CPU 411a completes preparation for recovery, and sends a recovery preparation completion notification to the second CPU 411b.

In step 2125, the second CPU 411b receives a controller startup completion notification.

In step 2126, the second CPU 411b notifies the terminal t1 of update completion.

In step 2127, the terminal t1 completes the OS update.

In step 2128, the second CPU 411b sends the remaining I/O information to the first CPU 411a.

In step 2129, the first CPU 411a sends the remaining I/O transfer instruction (transfer execution and interruption instruction) to the first protocol chip 421a. In step 2130, the first protocol chip 421a performs the remaining I/O processing.

In step 2131, the first protocol chip 421a transfers the queue elements to the first controller 410a, and notifies the first CPU 411a of interruption completion.

### Advantages

As described above, the storage system 200 according to the embodiment of the present invention is able to provide continuous I/O processing by switching a queue used for I/O control in accordance with an instruction from the side toward the controller 410 when the CPU 411 is to be halted. When the CPU 411 of the controller 410 is rebooted, the storage system 200 according to the embodiment is able to reduce the possibility of losing a command received by the controller 410. The storage system 200 according to the embodiment eliminates the necessity of changing the settings of the protocol chip 421 (resetting the protocol chip 421) when making a queue mapping change. This reduces the possibility of link disconnection and I/O loss due to a reset.

Further, the storage system 200 according to the embodiment of the present invention processes not only new I/Os but also remaining I/Os after queue switching processing. This reduces the possibility of I/O control being left uncompleted, and thus reduces the possibility of I/O loss.

Furthermore, if a predetermined time has elapsed after queue switching processing without processing the remaining I/Os, the storage system 200 according to the embodiment of the present invention interrupts the remaining I/Os in order to suppress an increase in the time for OS update.

Moreover, the storage system 200 according to the embodiment of the present invention is able to solve the problems of the conventional technology described below.

In a case where a multi-queue function is used, the conventional technology makes it possible to have two or more queues in advance and assign different CPUs to the queues for use. However, as regards the distribution of commands to these queues, the commands received from the host server need to be distributed to one of multiple queues by using a Fibre Channel port ID. Therefore, a separate port ID is additionally required for distribution. If such a separate port ID is additionally used, the host server needs to understand the differences between the port IDs and distribute I/O control accordingly. This causes a problem because such distribution of I/O control is not suitable for systems having a common FC.

Meanwhile, the storage system 200 according to the embodiment of the present invention is able to use the queue combination table 5000 in such a manner as to distribute queues to which I/O commands are to be sent. This solves the above problem.

### MODIFICATIONS

The present invention is not limited to the above-described embodiment. Various modifications can be adopted without departing from the scope of the present invention. The above embodiment may be applied to a case where the CPU 411 of the controller 410 halts due to a fault. For example, if the first CPU 411a of the first controller halts due to a failure, the communication path for the I/O commands may be changed by updating the queue combination table 5000 in such a manner that the queue to which the I/O commands are sent from the first protocol chip 421a corresponding to the first controller 410a serves as a queue assigned to the second CPU 411b other than the first CPU 411a that halted due to the failure.

In the above embodiment, the second CPU 411b may be halted in response to an instruction from the second controller 410b in order to switch the Qset for sending the I/O commands received by the second protocol chip 421b from Qset 21 to Qset 22.

What is claimed is:

1. A storage system comprising:
a first protocol chip and a second protocol chip that receive I/O commands from a host;
a first controller that includes a first CPU to which a queue used for control communication with the first protocol chip and a queue used for control communication with the second protocol chip are assigned;
a second controller that includes a second CPU to which a queue used for control communication with the first protocol chip and a queue used for control communication with the second protocol chip are assigned;
a first PCI switch that is disposed between the first protocol chip and the first and second CPUs and configured to set a communication path between the first protocol chip and the first CPU and a communication path between the first protocol chip and the second CPU; and
a second PCI switch that is disposed between the second protocol chip and the first and second CPUs and configured to set a communication path between the second protocol chip and the first CPU and a communication path between the second protocol chip and the second CPU;
wherein the first and second protocol chips each have queue control information that defines the queue at a transmission destination of the I/O commands received from the host, and
cause the first and second PCI switches to set the communication path for the I/O commands in accordance with the queue control information.

2. The storage system according to claim 1,
wherein either one of the first controller and the second controller
sends a queue switching instruction to either one of the first protocol chip and the second protocol chip, and
upon receiving the queue switching instruction, either one of the first protocol chip and the second protocol chip
updates the queue control information in accordance with the queue switching instruction so as to switch the communication path for the I/O commands to the communication path according to the updated queue control information.

3. The storage system according to claim 2,
wherein the communication path between the first protocol chip and the first CPU is a communication path for normal I/O processing that is used when the first CPU is not halted, and the communication path between the first protocol chip and the second CPU is a communication path for alternative I/O processing that is used when the first CPU is halted,
when halting the first CPU, the first controller sends the queue switching instruction to the first protocol chip, and
the first protocol chip switches the communication path for the I/O commands received by the first protocol chip from a communication path for the normal I/O processing to a communication path for the alternative I/O processing in accordance with the queue switching instruction.

4. The storage system according to claim 3,
wherein the communication path between the second protocol chip and the second CPU
is a communication path for normal I/O processing that is used when the second CPU is not halted,
the communication path between the second protocol chip and the first CPU
is a communication path for alternative I/O processing that is used when the second CPU is to be halted,
when halting the second CPU, the second controller sends the queue switching instruction to the second protocol chip, and
the second protocol chip
switches the communication path for the I/O commands received by the second protocol chip from a communication path for the normal I/O processing to a communication path for the alternative I/O processing in accordance with the queue switching instruction.

5. The storage system according to claim 2,
wherein each of the first and second CPUs is a multicore CPU in an SMP OS, and
when updating the SMP OS running on the first CPU, the first protocol chip updates the queue control information so as to switch the queue at a transmission destination of the I/O commands received by the first protocol chip from a queue assigned to the first CPU to a queue assigned to the second CPU.

6. The storage system according to claim 5,
wherein, when updating the SMP OS running on the second CPU, the second protocol chip updates the queue control information so as to switch the queue at a transmission destination of the I/O commands received by the second protocol chip from a queue assigned to the second CPU to a queue assigned to the first CPU.

7. The storage system according to claim 2,
wherein a queue set, including an RQ, a WQ, and a CQ, is assigned to each of the first and second CPUs, the RQ receiving the I/O commands, the WQ being a message send queue for making an I/O execution request, the CQ being a message receive queue for receiving a message indicating the completion of an I/O data transfer initiated in response to the I/O execution request, and
upon receiving the queue switching instruction, either one of the first protocol chip and the second protocol chip
confirms a state where unprocessed queue information remains in the queue set at a switching source, and performs processing in accordance with the confirmed state.

8. The storage system according to claim 7,
wherein, upon receiving the queue switching instruction, either one of the first protocol chip and the second protocol chip
checks the queue information regarding the RQ at the switching source to confirms a state where the I/O commands remain, copies the I/O commands remaining in the RQ, loads the copied I/O commands into a queue at a switching destination, and processes the unprocessed queue information.

9. The storage system according to claim 7,
wherein, upon receiving the queue switching instruction, either one of the first protocol chip and the second protocol chip
checks the queue information regarding the WQ at the switching source to confirm a state where I/O transfer requests remain, and processes the I/O transfer requests remaining in the WQ.

10. The storage system according to claim 7,
wherein, upon receiving the queue switching instruction, either one of the first protocol chip and the second protocol chip
checks remaining I/Os associated with I/O completion notifications left loaded in the CQ at the switching source to determine whether predetermined conditions are satisfied, and when the predetermined conditions are satisfied, either one of the first protocol chip and the second protocol chip sends the information regarding the remaining I/Os to either one of the first controller and the second controller, whichever sent the queue switching instruction, and interrupts the processing on the remaining I/Os.

11. The storage system according to claim 7,
wherein the first controller includes a first memory,
the second controller includes a second memory,
a first hot queue set is created in the first memory of the first controller, the first hot queue set being used as the queue set for processing the I/O commands that are received by the first protocol chip when the first CPU is not halted,
a first standby queue set is created in the second memory of the second controller, the first standby queue set being used as the queue set for processing the I/O commands that are received by the first protocol chip when the first CPU is halted,
a second hot queue set is created in the second memory of the second controller, the second hot queue set being used as the queue set for processing the I/O commands that are received by the second protocol chip when the second CPU is not halted, and
a second standby queue set is created in the first memory of the first controller, the second standby queue set being used as the queue set for processing the I/O commands that are received by the second protocol chip when the second CPU is halted.

12. The storage system according to claim 11,
wherein, when halting the first CPU of the first controller, the first protocol chip switches the communication path in such a manner that the I/O commands received by the first protocol chip from the host are sent to the first standby queue set, and
when halting the second CPU of the second controller, the second protocol chip switches the communication path in such a manner that the I/O commands received by the second protocol chip from the host are sent to the second standby queue set.

13. The storage system according to claim 2,
wherein, when either one of the first CPU and the second CPU is halted due to a failure,
either one of the first protocol chip and the second protocol chip updates the queue control information in such a manner that the queue at a transmission destination of the received I/O commands serves as a queue assigned to either one of the first CPU and the second CPU, whichever is not halted due to a failure.

14. A storage system comprising:
a first protocol chip and a second protocol chip that receive I/O commands from a host;
a first controller and a second controller that include a CPU configured to receive the I/O commands from the first protocol chip and the second protocol chip;
a first communication path between the first protocol chip and the first controller;
a second communication path between the second protocol chip and the second controller;
a third communication path between the first protocol chip and the second controller;
a fourth communication path between the second protocol chip and the first controller;
a first PCI switch that switches the communication path for the I/O commands received by the first protocol chip to either one of the first communication path and the third communication path in accordance with an instruction from a controller side; and
a second PCI switch that switches the communication path for the I/O commands received by the second protocol chip to either one of the second communication path and the fourth communication path in accordance with an instruction from the controller side.

15. A storage system management method that is applied to a storage system including
a first protocol chip, a second protocol chip, a first controller, a second controller, a first PCI switch, and a second PCI switch;
wherein the first protocol chip and the second protocol chip receive I/O commands from a host;
the first controller includes a first CPU to which a queue used for control communication with the first protocol chip and a queue used for control communication with the second protocol chip are assigned;
the second controller includes a second CPU to which a queue used for control communication with the first protocol chip and a queue used for control communication with the second protocol chip are assigned;
the first PCI switch is disposed between the first protocol chip and the first and second CPUs and configured to set a communication path between the first protocol chip and the first CPU and a communication path between the first protocol chip and the second CPU;
the second PCI switch is disposed between the second protocol chip and the first and second CPUs and configured to set a communication path between the second protocol chip and the first CPU and a communication path between the second protocol chip and the second CPU;
the first protocol chip and the second protocol chip each have queue control information that defines the queue at a transmission destination of the I/O commands received from the host, and
cause the first and second PCI switches to set the communication path for the I/O commands in accordance with the queue control information.
